(19) United States
(12) Patent Application Publication
(10) Pub. No.: US 2026/0370869 A1
(43) Pub. Date: Nov. 19, 2026

(54) VIDEO SIGNAL CODING METHOD, AND PROCESSING APPARATUS AND READABLE STORAGE MEDIUM

(71) Applicant: Shanghai Cambricon Information Technology Co., Ltd, Shanghai (CN)

(72) Inventor: Li YIN, Shanghai (CN)

(21) Appl. No.: 19/478,249

(22) PCT Filed: Apr. 8, 2024
(86) PCT No.: PCT/CN2024/086653

§ 371 Date: Oct. 23, 2025

(30) Foreign Application Priority Data
Apr. 24, 2023 (CN) 202310453707.7

(51) Int. Cl. H04N 19/567; H04N 19/105; H04N 19/139; H04N 19/172; H04N 19/182; H04N 19/52

(52) U.S. Cl. CPC H04N 19/567; H04N 19/105; H04N 19/139; H04N 19/172; H04N 19/182; H04N 19/52

(57) ABSTRACT

The present disclosure provides a method for coding a video signal, a processing device, and a readable storage medium. The processing device includes a processor and a memory, where the memory is configured to store computer execution instructions, and the processor is configured to execute the computer execution instructions stored in the memory, so that the processing device performs the method for coding the video signal. The embodiments of the present disclosure may reduce processing overhead, lower implementation complexity, and reduce the implementation cost of the processing device.

### CROSS REFERENCE TO RELATED APPLICATION

The present application claims priority to Chinese Patent Application No. 202310453707.7 filed on Apr. 24, 2023, the entire content of which is incorporated by reference into this application.

### TECHNICAL FIELD

The present disclosure relates to the field of video coding, and in particular to a method for coding a video signal, a processing device, and a readable storage medium.

### BACKGROUND

The purpose of inter-frame coding in video coding is to exploit temporal correlations within video and eliminate temporal redundancy. Specifically, by searching for the best matching block of blocks to be coded in the current image frame in the reference frame, a motion vector (MV) and difference values of luminance (or chrominance) between co-located pixels of the block to be coded and the best matching block are obtained. Then, a difference value of the MV and the difference values of the luminance (or chrominance) are coded, which may improve the efficiency of video compression.

Motion in videos is usually continuous, and integer pixel precision sometimes cannot well represent the motion of objects. Therefore, adaptive motion vector resolution (AMVR) technique has been proposed. The video coding device performs motion estimation on reference frames with integer pixel precision, half pixel precision, quarter pixel precision, and fourfold pixel precision to determine an optimal matching block corresponding to an optimal precision, and implement inter-frame coding of AMVR.

However, the current inter-frame coding using AMVR technique still has problems such as heavy processing overhead and high implementation cost.

### SUMMARY

The present disclosure provides a method for coding a video signal, a processing device and a readable storage medium to solve the problems of heavy processing overhead and high implementation cost in the current inter-frame coding using AMVR technique.

A first aspect of the present disclosure provides a method for coding a video signal, including:
determining a first rate-distortion cost and a second rate-distortion cost corresponding to a corresponding reference unit based on a set of deviations corresponding to each of a plurality of reference units contained in a reference frame at first pixel precision, where the set of deviations is a set of scale deviations of co-located pixels between the corresponding reference unit and the unit to be coded, the first rate-distortion cost is a rate-distortion cost corresponding to first pixel precision, and the second rate-distortion cost is a rate-distortion cost corresponding to second pixel precision;
determining an optimal motion vector corresponding to the first pixel precision and a starting motion vector corresponding to the second pixel precision, where the optimal motion vector corresponding to the first pixel precision is a motion vector between a reference unit with a smallest first rate-distortion cost among the plurality of reference units and the unit to be coded, and the starting motion vector corresponding to the second pixel precision is a motion vector between a reference unit with a smallest second rate-distortion cost among the plurality of reference units and the unit to be coded, and the starting motion vector corresponding to the second pixel precision is used to determine an optimal motion vector corresponding to the second pixel precision; and
performing inter-frame coding on the unit to be coded according to a first optimal motion vector to output a coding sequence, where the first optimal motion vector is a motion vector with a smallest rate-distortion cost among optimal motion vectors corresponding to a plurality of pixel precisions, and the plurality of pixel precisions include the first pixel precision and the second pixel precision.

A second aspect of the present disclosure provides a processing device, including:
a first motion estimation (ME) unit configured to determine a first rate-distortion cost and a second rate-distortion cost corresponding to a corresponding reference unit based on a set of deviations corresponding to each of a plurality of reference units contained in a reference frame at first pixel precision, where the set of deviations is a set of scale deviations of co-located pixels between the corresponding reference unit and the unit to be coded, the first rate-distortion cost is a rate-distortion cost corresponding to first pixel precision, and the second rate-distortion cost is a rate-distortion cost corresponding to second pixel precision, where
the first ME unit is further configured to output an optimal motion vector corresponding to the first pixel precision and a starting motion vector corresponding to the second pixel precision, where the optimal motion vector corresponding to the first pixel precision is a motion vector between a reference unit with the smallest first rate-distortion cost among the plurality of reference units and the unit to be coded, and the starting motion vector corresponding to the second pixel precision is a motion vector between a reference unit with the smallest second rate-distortion cost among the plurality of reference units and the unit to be coded, and the starting motion vector corresponding to the second pixel precision is used to determine an optimal motion vector corresponding to the second pixel precision; and
a coding unit configured to perform inter-frame coding on the unit to be coded according to a first optimal motion vector to output a coding sequence, where the first optimal motion vector is a motion vector with the smallest rate-distortion cost among optimal motion vectors corresponding to a plurality of pixel precisions, and the plurality of pixel precisions include the first pixel precision and the second pixel precision.

A third aspect of the present disclosure provides a chip, including: a logic circuit and an input/output interface, where the logic circuit is configured to control the input/output interface and perform the method of the first aspect.

A fourth aspect of the present disclosure provides a processing device, including a processor and a memory, where the memory is configured to store computer execution instructions, and the processor is configured to execute the computer execution instructions stored in the memory, so that the processing device performs the method of the first aspect.

A fifth aspect of the present disclosure provides a computer program product, which includes a computer program (also referred to as code or instruction), which, when executed, enables a computer to perform the method of the first aspect.

A sixth aspect of the present disclosure provides a computer-readable medium, which stores a computer program (also referred to as code or instruction) which, when executed on a computer, enables the computer to perform the method of the first aspect.

The present disclosure provides a method for coding a video signal, a processing device, and a readable storage medium. During the inter-frame coding process of the video signal, when the processing device performs motion estimation in a reference frame at a pixel precision, based on the set of deviations corresponding to the searched reference unit, the processing device determines both the optimal motion vector corresponding to the pixel precision and the starting motion vector for searching for the next pixel precision. During this process, a large number of intermediate results are reused, which greatly reduces processing overhead, lowers implementation complexity, and reduces the implementation cost of the processing device.

### BRIEF DESCRIPTION OF DRAWINGS

The accompanied drawings herein are incorporated into the specification and constitute a part of the specification, illustrate embodiments that conform to the present disclosure, and are used together with the specification to explain principles of the present disclosure.

FIG. 1 is a schematic diagram of an application scenario applicable to an image processing method provided in this disclosure.

FIG. 2 is a schematic diagram of AMVR motion estimation provided by this disclosure.

FIG. 3 is a schematic flow chart of a method for coding a video signal provided by this disclosure.

FIG. 4 is another schematic flow chart of a method for coding a video signal provided by this disclosure.

FIG. 5 is a schematic diagram of a structure of a processing device provided by this disclosure.

FIG. 6 is another schematic diagram of a structure of a processing device provided by this disclosure.

The above drawings have shown specific embodiments of the present disclosure, which will be described in more detail below. These drawings and textual descriptions are not intended to limit the scope of the present disclosure in any way, but rather to explain the concept of the present disclosure to those skilled in the art by referring to specific embodiments.

### DETAILED DESCRIPTION

In order to make the objectives, technical solutions and advantages of the present disclosure clearer, the embodiments of the present disclosure will be described in further detail below with reference to the accompanying drawings.

It should be clear that the described embodiments are only part of the embodiments of this disclosure, rather than all the embodiments. All other embodiments obtained by those of ordinary skill in the art based on the embodiments of the present disclosure without creative efforts shall fall within the protection scope of the present disclosure.

Unless otherwise indicated, identical numbers in different drawings indicate identical or similar elements. The implementation manners described in the following exemplary embodiments do not represent all implementation manners consistent with the present disclosure. On the contrary, the implementation manners are only examples of apparatuses and methods which are consistent with some aspects of the present disclosure and specifically described in the appended claims.

In the description of this disclosure, it should be understood that the terms “first”, “second”, “third”, etc. are only used to distinguish similar objects, and are not necessarily used to describe a specific order or sequence, nor can they be understood as indicating or implying relative importance. For those skilled in the art, the specific meanings of the above terms in this disclosure may be understood according to specific circumstances. In addition, in the descriptions of the present disclosure, unless otherwise specified, “a plurality of” means two or more. “And/or” describes the association relationship of associated objects, indicating that three relationships may exist. For example, A and/or B may mean: A exists alone, A and B exist at the same time, and B exists alone. The character “/” generally indicates that the previous and next associated objects are in an “or” relationship.

The technical solutions involved in the embodiments of the present disclosure are applied to video coding systems, such as video coding systems that apply standards such as H.264/advanced video coding (AVC), H.265/high efficiency video coding (HEVC), and H.266/versatile video coding (VVC), as well as other video coding systems and video coding systems in the future evolution.

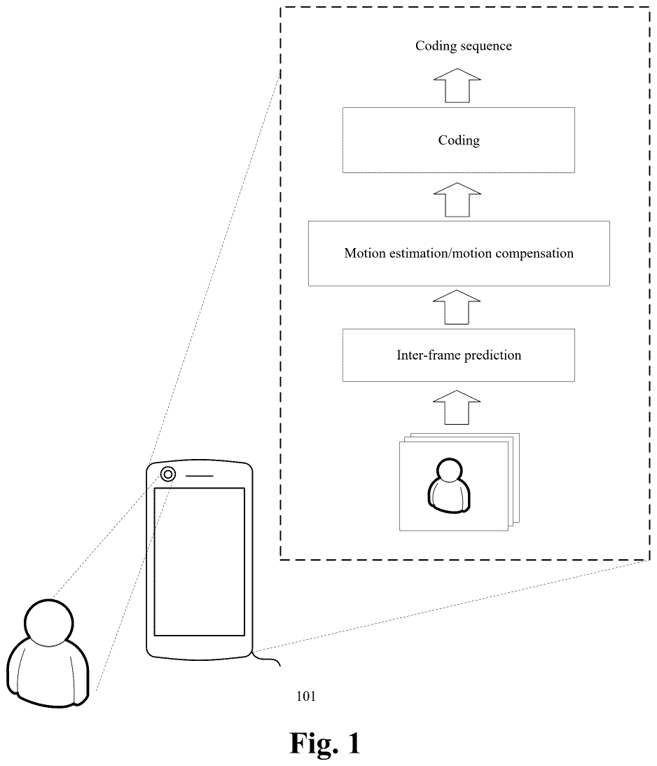

FIG. 1 is a schematic diagram of an application scenario applicable to a method for coding a video signal provided in this disclosure. A processing device 101 may process a video signal and code an image frame of the video signal for transmission, storage, etc. For example, the processing device 101 may perform inter-frame prediction, motion estimation, and motion compensation on the image frame of the video signal, and obtain a coding sequence of the image frame through coding. The processing device 101 may perform image acquisition to obtain the video signal, or the processing device 101 may obtain the video signal from other devices, which is not limited in this disclosure. The processing device 101 may be a smart phone, a tablet computer, a computer, a camera device, etc. This disclosure does not limit the specific form of the processing device.

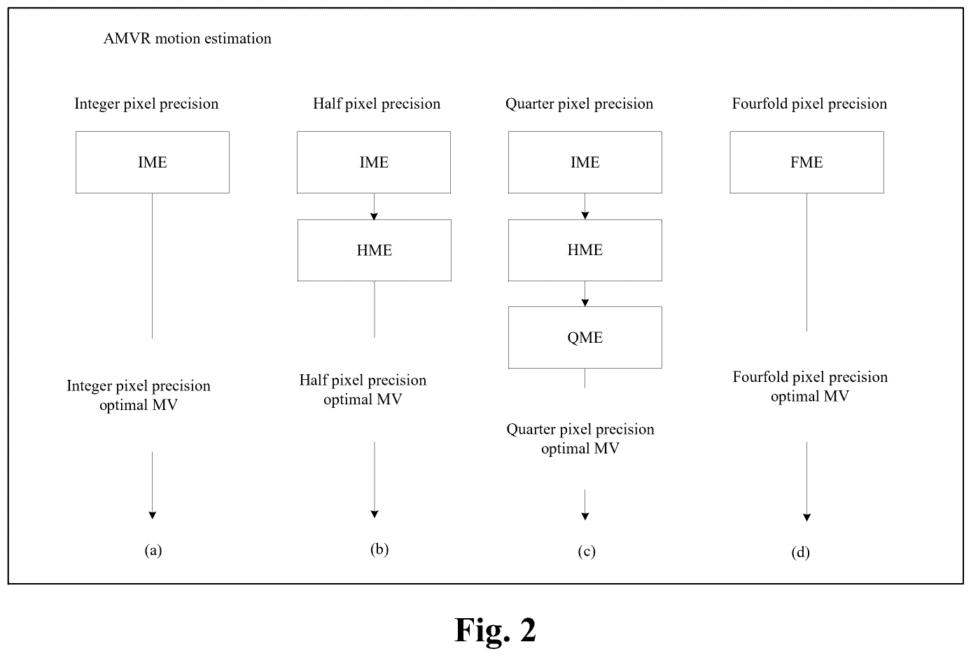

When implementing AMVR motion estimation, a video coding device typically performs motion estimation at integer pixel precision, half pixel precision, quarter pixel precision, and fourfold pixel precision respectively. As shown in FIG. 2, when the video coding device performs integer pixel precision motion estimation (IME) in (a), a matching reference unit of the image to be coded is searched for in the reference frame at integer pixel precision, and a coding length (i.e., code length) of a motion vector difference (MVD) corresponding to the reference unit is determined using MVD at integer pixel precision. As such, a rate-distortion cost corresponding to the reference unit is determined based on the code length corresponding to the integer pixel precision and a deviation (in other words, a difference value) of luminance (or chrominance) between the reference unit and the unit to be coded, and an optimal MV corresponding to the integer pixel precision is searched for based on a rate-distortion cost corresponding to each reference unit. The MVD is a deviation between the MV corresponding to the reference unit and a predicted MV (PMV). The optimal MV corresponding to the integer pixel precision is the MV between the searched matching reference unit at integer pixel precision and the unit to be coded.

When the video coding device performs half pixel precision motion estimation (HME) in (b), it is necessary to first determine the code length of the MVD in the reference frame at integer pixel precision using the MVD at half pixel precision of the searched reference unit, and then determine the rate-distortion cost corresponding to the reference unit. As such, based on the rate-distortion cost corresponding to each reference unit obtained by the search, the starting reference unit for searching in the reference frame at half pixel precision is determined, thereby obtaining an optimal MV corresponding to half pixel precision in the reference frame at half pixel precision.

The video coding device performs quarter pixel precision motion estimation (QME) in (c) similarly, determining the code length of the MVD using the MVD at quarter pixel precision of the searched reference unit, searching and determining a search starting reference unit at half pixel precision in the reference frame at integer pixel precision, and then determining the code length of the MVD using the MVD at quarter pixel precision of the reference unit, searching and determining the search starting reference unit at quarter pixel precision in the reference frame at half pixel precision, and searching in the reference frame at quarter pixel precision to obtain an optimal MV corresponding to quarter pixel precision.

When the video coding device performs fourfold pixel precision motion estimation (FME) in (d), the code length of the MVD is determined using the MVD at fourfold pixel precision of each reference unit in the reference frame at fourfold pixel precision, and the rate-distortion cost corresponding to each reference unit is obtained, thereby determining an optimal MV corresponding to fourfold pixel precision.

Based on the above introduction, in order to determine optimal MVs corresponding to integer pixel precision, half pixel precision, and quarter pixel precision, integer pixel precision motion estimation is required. However, when the rate-distortion cost of the reference unit is obtained, the code length is determined using MVDs at different pixel precisions. In addition, in order to determine optimal MVs corresponding to half pixel precision and quarter pixel precision, half pixel precision motion estimation is required, but when the rate-distortion cost of the reference unit is obtained, the code length is determined using MVDs at half pixel precision and quarter pixel precision respectively. This method is easy to implement through software, but is more complex and costly to implement through hardware.

The present disclosure provides a method for coding a video signal. During the inter-frame coding process of the video signal, when the processing device performs motion estimation in a reference frame at a pixel precision, based on the set of deviations corresponding to the searched reference unit, the processing device determines both the optimal motion vector corresponding to the pixel precision and the starting motion vector for searching for the next pixel precision. During this process, a large number of intermediate results are reused, thereby greatly reducing processing overhead, lowering implementation complexity, and reducing the implementation cost of the processing device.

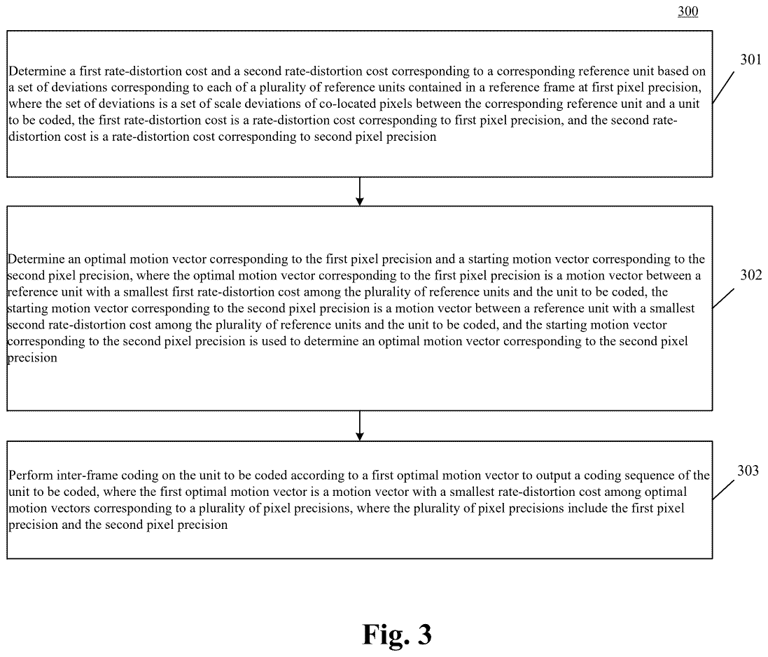

FIG. 3 is a schematic flow chart of a method 300 for coding a video signal provided by this disclosure. The method may be performed by a processing device, which may be a processing equipment, or the processing device may be configured in the processing equipment, for example, the processing device may be a chip or a chip system configured in the processing equipment. However, the present disclosure has no limitation on this. The method includes but is not limited to steps S301 to S303.

When the processing device needs to perform inter-frame coding on a current frame in a video signal, the processing device determines a reference frame. For example, the reference frame may be a reconstructed frame of an adjacent frame of the current frame.

For the unit to be coded in the current frame, AMVR technique is applied, and the processing device performs motion estimation in reference frames with a plurality of pixel precisions. According to a matching criterion and a search algorithm, a matching reference unit of the unit to be coded corresponding to each pixel precision is obtained by searching, thereby determining an optimal matching reference unit of the unit to be coded among matching reference units of the unit to be coded corresponding to a plurality of pixel precisions. The plurality of pixel precisions at least include first pixel precision and second pixel precision.

The following is a detailed introduction to the method for determining the optimal matching reference unit to perform inter-frame coding on the unit to be coded provided in the embodiment of the present disclosure.

In S301, a first rate-distortion cost and a second rate-distortion cost corresponding to a corresponding reference unit are determined based on a set of deviations corresponding to each of a plurality of reference units contained in a reference frame at first pixel precision. The set of deviations is a set of scale deviations of co-located pixels between the corresponding reference unit and a unit to be coded. The first rate-distortion cost is the rate-distortion cost corresponding to first pixel precision. The second rate-distortion cost is the rate-distortion cost corresponding to second pixel precision.

The scale may be luminance or chrominance.

In order to determine the matching reference unit of the unit to be coded in the reference frame at each pixel precision in the plurality of pixel precisions, the processing device may first determine, in the reference frame at the first pixel precision, for each searched reference unit, a set of deviations of co-located pixels between the reference unit and the unit to be coded, which is a deviation set. The reference unit and the unit to be coded contain the same number of pixels and have the same size. Two pixels located at the same position in the reference unit and the unit to be coded are called co-located pixels.

After determining the set of deviations corresponding to the reference unit, the processing device may determine the first rate-distortion cost and the second rate-distortion cost corresponding to the reference unit according to the set of deviations corresponding to the reference unit.

The following is a specific explanation using an example in which the processing device determines the first rate-distortion cost and the second rate-distortion cost corresponding to a first reference unit based on a set of deviations corresponding to the first reference unit, where the first reference unit may be any reference unit searched by the processing device in the reference frame at first pixel precision. In other words, a first rate-distortion cost and a second rate-distortion cost corresponding to any reference unit searched by the processing device in the reference frame at first pixel precision may be determined by referring to the method for determining the first rate-distortion cost and the second rate-distortion cost corresponding to the first reference unit below.

The processing device determines the first rate-distortion cost corresponding to the first reference unit based on the set of deviations corresponding to the first reference unit, including the following: the processing device determines a first code length based on a motion vector difference (MVD) between a first motion vector and a predicted motion vector (PMV), where the first code length is a coding length of MVD at first pixel precision. The first motion vector is the motion vector between the first reference unit and the unit to be coded. The processing device then determines the first rate-distortion cost of the reference unit according to the set of deviations corresponding to the first reference unit and the first code length.

Exemplarily, the first rate-distortion cost C_{RD1} of the first reference unit determined by the processing device satisfies the following formula:

C_{RD1}=d+λR₁

d is the degree of matching between the scales of the first reference unit and the unit to be coded, determined using a matching criterion based on the set of deviations. λ is a predefined Lagrange constant. R₁ is the first code length.

The matching criterion adopted by the processing device may be mean absolute differences (MAD), sum of squared difference (SSD), mean squared error (MSE), sum of absolute difference (SAD) or sum of absolute transformed difference (SATD). The present disclosure has no limitation on this.

In addition, the processing device determines the second rate-distortion cost corresponding to the first reference unit based on the set of deviations corresponding to the first reference unit, including the following: the processing device determines a second code length based on the MVD corresponding to the first reference unit, where the second code length is a coding length of the MVD at second pixel precision. The processing device then determines the second rate-distortion cost corresponding to the first reference unit according to the set of deviations corresponding to the first reference unit and the second code length.

Exemplarily, the second rate-distortion cost C_{RD2} of the first reference unit determined by the processing device satisfies the following formula:

C_{RD2}=d+λR₂
d and λ are the same as d and λ when the processing device determines the first rate-distortion cost. R₂ is the second code length. Exemplarily, R₁ is a first-order Golomb code length of MVD at first pixel precision corresponding to the first reference unit, and R₂ is a first-order Golomb code length of MVD at second pixel precision corresponding to the first reference unit.

According to the above solution, when the processing device performs motion estimation in a reference frame at first pixel precision, after determining a set of deviations for the searched reference unit, based on the set of deviations, the processing device determines both a rate-distortion cost at first pixel precision corresponding to the reference unit (in other words, a first rate-distortion cost) and a rate-distortion cost at second pixel precision corresponding to the reference unit (in other words, a second rate-distortion cost). The first rate-distortion cost is used to determine a matching reference unit at first pixel precision corresponding to the unit to be coded, and the second rate-distortion cost is used to determine a starting reference unit for the processing device to search for a matching reference unit in a reference frame at second pixel precision. The set of deviations of the reference unit may be reused, thereby reducing processing overhead, lowering implementation complexity and implementation cost.

For example, the first pixel precision and the second pixel precision may be two different pixel precisions in the integer pixel precision, half pixel precision, quarter pixel precision, and fourfold pixel precision.

In an implementation, the processing device obtains a starting motion vector corresponding to the first pixel precision. The processing device searches for a matching reference unit of the unit to be coded corresponding to the first pixel precision in the reference frame at first pixel precision according to the starting motion vector corresponding to the first pixel precision, to determine the optimal motion vector corresponding to the first pixel precision and the starting motion vector corresponding to the second pixel precision.

In an example, if the first pixel precision is integer pixel precision, the processing device may start searching for the matching reference unit from a preset reference unit in the reference frame at integer pixel precision as a starting reference unit. For example, the preset reference unit may be a co-located reference unit of the unit to be coded in the reference frame. Alternatively, the processing device obtains the PMV and uses the reference unit whose motion vector with the unit to be coded is the PMV as the starting reference unit to start searching for the matching reference unit.

In another example, if the first pixel precision is not integer pixel precision, the processing device may search for the matching reference unit in the reference frame at fourth pixel precision, determine an optimal motion vector at fourth pixel precision, and also determine a starting motion vector corresponding to the first pixel precision. The processing device determines, based on the starting motion vector corresponding to the first pixel precision, a starting reference unit for searching for the matching reference unit in the reference frame at first pixel precision, and starts searching from the starting reference unit. Specifically, the processing device may determine a set of deviations of each searched reference unit, and determine a corresponding first rate-distortion cost and a corresponding second rate-distortion cost.

Exemplarily, the fourth pixel precision may be integer pixel precision, the first pixel precision may be half pixel precision, and the second pixel precision may be quarter pixel precision.

In S302, an optimal motion vector corresponding to first pixel precision and a starting motion vector corresponding to second pixel precision are determined, where the optimal motion vector corresponding to the first pixel precision is a motion vector between a reference unit with a smallest first rate-distortion cost among a plurality of reference units and the unit to be coded, the starting motion vector corresponding to the second pixel precision is a motion vector between a reference unit with a smallest second rate-distortion cost among a plurality of reference units and the unit to be coded, and the starting motion vector corresponding to the second pixel precision is used to determine an optimal motion vector corresponding to the second pixel precision.

After the processing device determines the first rate-distortion cost and the second rate-distortion cost of each searched reference unit in the reference frame at first pixel precision in S301, the processing device determines a reference unit with the smallest first rate-distortion cost among the searched reference units, which is a matching reference unit of the unit to be coded in the reference frame at first pixel precision, which may be called the matching reference unit of the unit to be coded corresponding to the first pixel precision, and the motion vector between the matching reference unit and the unit to be coded is the optimal motion vector corresponding to the first pixel precision.

The processing device further determines a reference unit with the smallest second rate-distortion cost among the searched reference units, and the reference unit is the starting reference unit for the processing device to search for the matching reference unit in the reference frame at second pixel precision. The motion vector between the reference unit and the unit to be coded is the starting motion vector corresponding to the second pixel precision.

In an implementation, the processing device further searches for the matching reference unit of the unit to be coded corresponding to the second pixel precision in the reference frame at second pixel precision based on the starting motion vector corresponding to the second pixel precision, to determine the optimal motion vector corresponding to the second pixel precision.

In these implementations, the processing device may determine the starting reference unit for searching for the matching reference unit in the reference frame at second pixel precision based on the starting motion vector corresponding to the second pixel precision, and then the processing device may start searching from the starting reference unit. The processing device may then determine a set of deviations of each searched reference unit. Similar to first pixel precision, after obtaining a set of deviations of a reference unit, the processing device may determine a rate-distortion cost corresponding to the reference unit. The rate-distortion cost here may include, for example, a third rate-distortion cost and a fourth rate-distortion cost. The third rate-distortion cost is the rate-distortion cost corresponding to the second pixel precision. The fourth rate-distortion cost may be a rate-distortion cost corresponding to third pixel precision. The third pixel precision here may be other pixel precision except the first pixel precision and the second pixel precision.

Then, among the plurality of reference units corresponding to the second pixel precision, the processing device may take the motion vector between the reference unit with the smallest second rate-distortion cost and the unit to be coded as the optimal motion vector corresponding to the second pixel precision.

In some implementations, the method further includes: determining a starting motion vector corresponding to the third pixel precision, where a plurality of pixel precisions include the third pixel precision.

For example, the third pixel precision is other pixel precision among the plurality of pixel precisions except the first pixel precision and the second pixel precision.

The processing device further determines a reference unit with the smallest fourth rate-distortion cost among the searched reference units, and the reference unit is the starting reference unit for the processing device to search for the matching reference unit in the reference frame at third pixel precision. The motion vector between the reference unit and the unit to be coded is the starting motion vector corresponding to the third pixel precision.

In S303, inter-frame coding is performed on the unit to be coded according to a first optimal motion vector to output a coding sequence. The first optimal motion vector is a motion vector with a smallest rate-distortion cost among optimal motion vectors corresponding to a plurality of pixel precisions, where the plurality of pixel precisions include first pixel precision and second pixel precision.

The processing device determines the motion vector with the smallest rate-distortion cost among the optimal motion vectors corresponding to the plurality of pixel precisions as the first optimal motion vector. In other words, the processing device searches for the matching reference unit corresponding to each pixel precision in the reference frame at a plurality of pixel precisions, determines the reference unit with the smallest rate-distortion cost, and the motion vector between the reference unit and the unit to be coded is the first optimal motion vector. The processing device performs inter-frame coding on the unit to be coded according to the first optimal motion vector to output a coded sequence of the unit to be coded. Specifically, the processing device may perform the inter-frame coding on the unit to be coded according to the set of deviations corresponding to the first optimal motion vector and the first optimal motion vector to output the coding sequence. The set of deviations corresponding to the first optimal motion vector is a set of scale deviations between the reference unit corresponding to the first optimal motion vector and the unit to be coded.

In an implementation, before the processing device performs the inter-frame coding on the unit to be coded according to the first optimal motion vector to output the coding sequence, the processing device determines a second optimal motion vector, which is a motion vector with the smallest rate-distortion cost among the optimal motion vectors corresponding to the plurality of pixel precisions. When the rate-distortion cost corresponding to the second optimal motion vector is greater than or equal to a threshold, a second reference unit in the reference frame at target pixel precision is used as a search starting point, and a target stride is used to search for a preset number of reference units to obtain rate-distortion costs corresponding to the preset number of reference units, where the second reference unit is the reference unit corresponding to the second optimal motion vector, and the target pixel precision is the pixel precision corresponding to the second reference unit.

A probability model is preset for the rate-distortion cost of each pixel precision among the plurality of pixel precisions, and a minimum threshold of the rate-distortion cost corresponding to the matching reference unit corresponding to each pixel precision may be determined according to the probability model. If the processing device determines that the rate-distortion cost corresponding to the second optimal motion vector (which is the rate-distortion cost corresponding to the second reference unit) among the optimal motion vectors corresponding to the plurality of pixel precisions obtained by searching is greater than or equal to the minimum threshold, it is considered that the second optimal motion vector may have an error. The processing device may use the second reference unit as the starting reference unit for the search in the reference frame at target pixel precision that has searched for the second reference unit, and continue to search for a preset number of reference units near the second reference unit using a target stride to obtain rate-distortion costs corresponding to the target number of reference units.

When the smallest rate-distortion cost among the rate-distortion costs corresponding to the preset number of reference units is less than the rate-distortion cost corresponding to the second reference unit, the processing device determines to update the optimal motion vector corresponding to the target pixel precision to a first optimal motion vector, where the first optimal motion vector is a motion vector between the reference unit corresponding to the smallest rate-distortion cost among the rate-distortion costs corresponding to the preset number of reference units and the unit to be coded. Then, after the optimal motion vector corresponding to the target pixel precision is updated to the first optimal motion vector, the motion vector with the smallest rate-distortion cost among the optimal motion vectors corresponding to the plurality of pixel precisions is changed to the first optimal motion vector. The processing device then performs inter-frame coding on the unit to be coded based on the first optimal motion vector to obtain a coded sequence of the unit to be coded.

When the smallest rate-distortion cost among the rate-distortion costs corresponding to the preset number of reference units is greater than or equal to the rate-distortion cost corresponding to the second reference unit, it is determined that the first optimal motion vector is the second optimal motion vector. In other words, if the rate-distortion costs corresponding to the preset number of reference units are all greater than or equal to the rate-distortion cost corresponding to the second reference unit, the processing device may deem that there is no error in the matching reference unit (which is the second reference unit) corresponding to the target pixel precision determined by it, and the processing device then performs inter-frame coding on the unit to be coded based on the second optimal motion vector corresponding to the second reference unit (at this time, the first optimal motion vector is the second optimal motion vector) to obtain a coding sequence.

According to the above solution, the processing device may verify the optimal motion vector corresponding to the unit to be coded determined by it to verify whether the determined optimal motion vector is actually the optimal motion vector. If it is determined after verification that it is not the optimal motion vector, the processing device updates the optimal motion vector corresponding to the unit to be coded. It may further improve the coding efficiency of inter-frame coding.

The solution provided by the present disclosure is that, during the inter-frame coding process of a video signal, when the processing device performs motion estimation in a reference frame at a pixel precision, based on a set of deviations corresponding to the searched reference unit, the processing device determines both an optimal motion vector corresponding to the pixel precision and a starting motion vector for searching for a next pixel precision. During this process, a set of deviations corresponding to each reference unit is reused. Compared with the method of obtaining the starting motion vector from low pixel precision to high pixel precision for each pixel precision in sequence to determine the optimal motion vector corresponding to the pixel precision, the solution may greatly reduce the processing overhead, lower the implementation complexity, and reduce the implementation cost of the processing device.

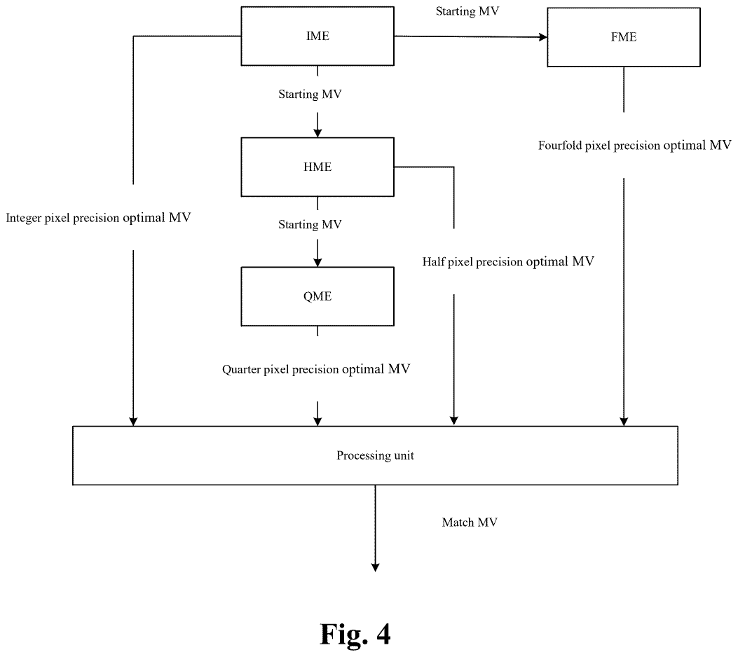

In a specific example, the processing device applies AMVR to perform motion estimation at integer pixel precision, fourfold pixel precision, half pixel precision, and quarter pixel precision to obtain the optimal motion vector of the unit to be coded, thereby performing inter-frame coding. As shown in FIG. 4, the processing device may include an IME unit, an HME unit, a QME unit, an FME unit, and a processing unit. The processing unit may also be referred to as a refine unit, but the present disclosure is not limited thereto. Furthermore, the processing device may further include other units not shown in FIG. 4. After the processing device obtains a video signal and determines a reference frame, the IME unit performs integer pixel motion estimation for the unit to be coded in the current frame. The IME unit searches for matching reference units with integer pixel precision in the reference frame at integer pixel precision, determines a set of deviations corresponding to each searched reference unit, and determines, based on a set of deviations corresponding to a reference unit, rate-distortion costs of the reference unit corresponding to integer pixel precision, half pixel precision, and fourfold pixel precision. The rate-distortion cost C_{RD-i} corresponding to pixel precision i satisfies:

C_{RD-i}=d+λRᵢ

when the IME unit determines the rate-distortion costs of the reference unit corresponding to the above three pixel precisions, the scale (for example, luminance or chrominance) matching degree d and the Lagrange constant λ are the same, where the scale matching degree d is determined based on a set of deviations of scale (luminance or chrominance) between the reference unit and the unit to be coded using a matching criterion, and the Lagrange constant λ is predefined. Rᵢ corresponding to the above three pixel precisions are different, and are all based on the code length corresponding to the corresponding pixel precision obtained after the MVD corresponding to the unit to be coded is converted to the corresponding pixel precision. If the code length may be a first-order Golomb code length, for integer pixel precision, the IME unit determines the first-order Golomb code length R_{INT} corresponding to the integer pixel precision using MVD at integer pixel precision. If the default precision of the processing device is quarter pixel precision, the MVD obtained by the IME unit based on the motion vector corresponding to the reference unit and PMV is the MVD at quarter pixel precision. The IME unit may convert the MVD at quarter pixel precision to integer pixel precision, such as shifting the MVD at quarter pixel precision right by 2 bits to align it to integer pixel precision, to obtain the MVD at integer pixel precision, thereby determining the first-order Golomb code length R_{INT} corresponding to the MVD at integer pixel precision. The IME unit then determines a rate-distortion cost C_{RD-INT} corresponding to integer pixel precision.

For half pixel precision, the IME unit determines the first-order Golomb code length R_{HALF} corresponding to half pixel precision using the MVD at half pixel precision. For example, the IME unit may shift the obtained MVD at quarter pixel precision right by 1 bit to align it to half pixel precision, thereby obtaining the MVD at half pixel precision, thereby determining the first-order Golomb code length R_{HALF} corresponding to the MVD at half pixel precision. The IME unit then determines a rate-distortion cost C_{RD-HALF} corresponding to half pixel precision.

For fourfold pixel precision, the IME unit determines the first-order Golomb code length R_{4PEL} corresponding to the fourfold pixel precision using the MVD at fourfold pixel precision. For example, the IME unit may shift the obtained MVD at quarter pixel precision right by 4 bits to align it to fourfold pixel precision to obtain the MVD at fourfold pixel precision, thereby determining the first-order Golomb code length R_{4PEL} corresponding to the MVD at fourfold pixel precision. The IME unit then determines a rate-distortion cost C_{RD-4PEL} corresponding to fourfold pixel precision.

The IME unit computes rate-distortion costs of each reference unit corresponding to three pixel precisions and reuses the scale matching degree d of the reference unit. This eliminates the need to repeatedly obtain the set of deviations corresponding to the reference unit at integer pixel precision for different pixel precisions, which may reduce implementation complexity, processing overhead, and implementation cost.

After the IME unit determines rate-distortion costs of each searched reference unit corresponding to integer pixel precision, half pixel precision, and fourfold pixel precision, the IME unit determines the smallest rate-distortion cost corresponding to integer pixel precision. The reference unit corresponding to the smallest rate-distortion cost is the matching reference unit of the unit to be coded in the reference frame at integer pixel precision. The IME unit outputs the motion vector between the matching reference unit and the unit to be coded, which is the optimal motion vector corresponding to integer pixel precision, to the processing unit.

The IME unit also determines a search starting reference unit at fourfold pixel precision. The IME unit determines the smallest rate-distortion cost corresponding to fourfold pixel precision. The reference unit corresponding to the smallest rate-distortion cost is the search starting reference unit at fourfold pixel precision. The motion vector between the reference unit and the unit to be coded is the starting motion vector corresponding to fourfold pixel precision. The IME unit may output the starting motion vector corresponding to fourfold pixel precision to the FME unit, so that the FME unit searches for the matching reference unit corresponding to fourfold pixel precision based on the starting motion vector.

The IME unit further determines a search starting reference unit at half pixel precision, and determines a starting motion vector corresponding to half pixel precision based on the smallest rate-distortion cost corresponding to half pixel precision. The IME unit may output the starting motion vector corresponding to half pixel precision to the HME unit, so that the HME unit searches for the matching reference unit corresponding to half pixel precision based on the starting motion vector.

After the HME unit in the processing device obtains the starting motion vector corresponding to half pixel precision from the IME unit, it determines a starting reference unit of a search matching reference unit at half pixel precision, and searches for a matching reference unit of the unit to be coded corresponding to half pixel precision in the reference frame at half pixel precision.

Similarly, the HME unit searches for matching reference units at half pixel precision in a reference frame at half pixel precision, determines a set of deviations corresponding to each searched reference unit, and determines a rate-distortion cost of the reference unit corresponding to half pixel precision and a rate-distortion cost of the reference unit corresponding to quarter pixel precision based on a set of deviations corresponding to a reference unit. Then, the HME unit determines an optimal motion vector corresponding to half pixel precision based on a rate-distortion cost of the searched reference unit corresponding to half pixel precision. Moreover, the HME unit determines a starting motion vector corresponding to quarter pixel precision based on a rate-distortion cost of the searched reference unit corresponding to quarter pixel precision. The HME unit determines first-order Golomb code lengths corresponding to half pixel precision and quarter pixel precision based on MVD at half pixel precision and MVD at quarter pixel precision respectively, and reuses a scale matching degree d of each reference unit, which may reduce implementation complexity, processing overhead and implementation cost.

The QME unit in the processing device obtains a starting motion vector corresponding to quarter pixel precision from the HME unit, searches for a matching reference unit at quarter pixel precision in a reference frame at quarter pixel precision, and determines a matching reference unit of the unit to be coded corresponding to quarter pixel precision. The FME unit obtains a starting motion vector corresponding to fourfold pixel precision from the IME unit, searches for a matching reference unit at fourfold pixel precision in a reference frame at fourfold pixel precision, and determines a matching reference unit of the unit to be coded corresponding to fourfold pixel precision.

The processing unit in the processing device may obtain optimal motion vectors corresponding to integer pixel precision, half pixel precision, quarter pixel precision and fourfold pixel precision respectively, and determine a motion vector with the smallest rate-distortion cost as a matching motion vector.

In an implementation, the processing device may perform inter-frame coding on the unit to be coded based on the matching motion vector and a set of deviations corresponding to the matching motion vector to obtain a coding sequence.

In another implementation, the processing unit determines a size relationship between a rate-distortion cost corresponding to the matching motion vector and a threshold. If the rate-distortion cost corresponding to the matching motion vector is greater than or equal to the threshold, the processing unit uses a matching reference unit corresponding to the matching motion vector as a starting search unit, and searches for a preset number of reference units in a reference frame at target pixel precision using a target stride to obtain rate-distortion costs corresponding to the preset number of reference units, where the target pixel precision is a pixel precision of a reference unit corresponding to the matching motion vector, and the target stride is the stride used when searching for the reference unit.

If the processing unit determines a minimum threshold of a rate-distortion cost corresponding to the target pixel precision based on a probability model corresponding to a motion vector at the target pixel precision, and the rate-distortion cost corresponding to the matching motion vector is greater than or equal to the threshold, the processing unit searches for and obtains rate-distortion costs corresponding to the preset number of reference units.

If the smallest rate-distortion cost among the rate-distortion costs corresponding to the preset number of reference units is less than the rate-distortion cost corresponding to the matching motion vector, the processing unit updates the matching motion vector, where the updated matching motion vector is a motion vector between the reference unit corresponding to the smallest rate-distortion cost among the rate-distortion costs corresponding to the preset number of reference units and the unit to be coded. The processing device performs inter-frame coding on the unit to be coded according to the updated matching motion vector and the set of deviations corresponding to the updated matching motion vector to obtain a coding sequence.

If the rate-distortion costs corresponding to the preset number of reference units are all not less than the rate-distortion cost corresponding to the matching motion vector, the processing unit may determine that the matching motion vector is the optimal motion vector in each pixel precision, and there is no need to update the optimal motion vector. The processing device performs the inter-frame coding on the unit to be coded based on the matching motion vector and the set of deviations corresponding to the matching motion vector to obtain the coding sequence.

According to the solution provided in the present disclosure, during the inter-frame coding process of the video signal, when the processing device performs motion estimation in a reference frame at a pixel precision, it determines the scale matching degree based on the set of deviations corresponding to the searched reference unit. By reusing the scale matching degree corresponding to each reference unit, the processing device not only determines the optimal motion vector corresponding to the pixel precision, but also determines the starting motion vector for searching for the next pixel precision. Compared with the method of independently obtaining the optimal motion vector for each pixel precision, the solution of the present disclosure may greatly reduce the processing overhead, the implementation complexity, and the implementation cost of the processing device.

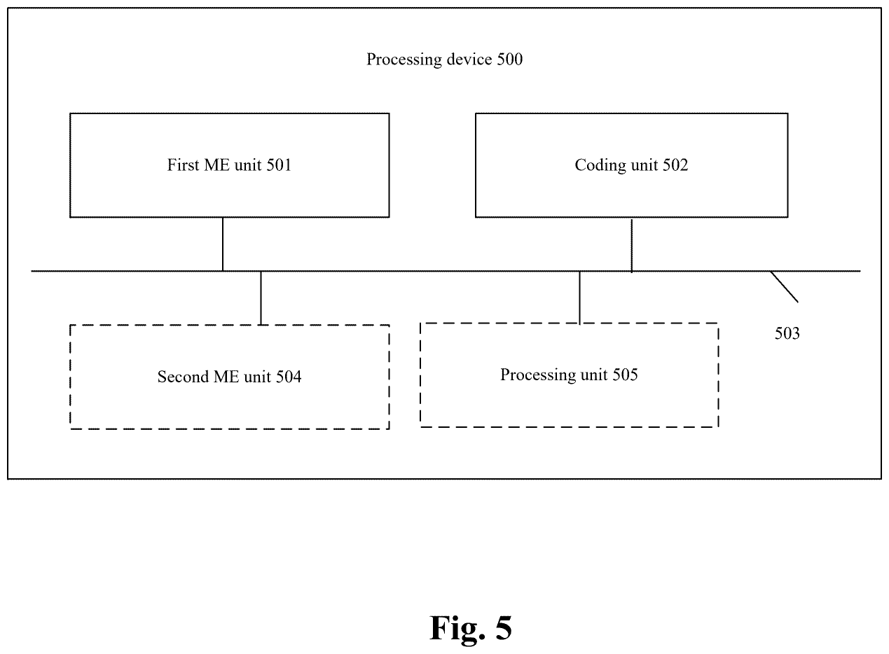

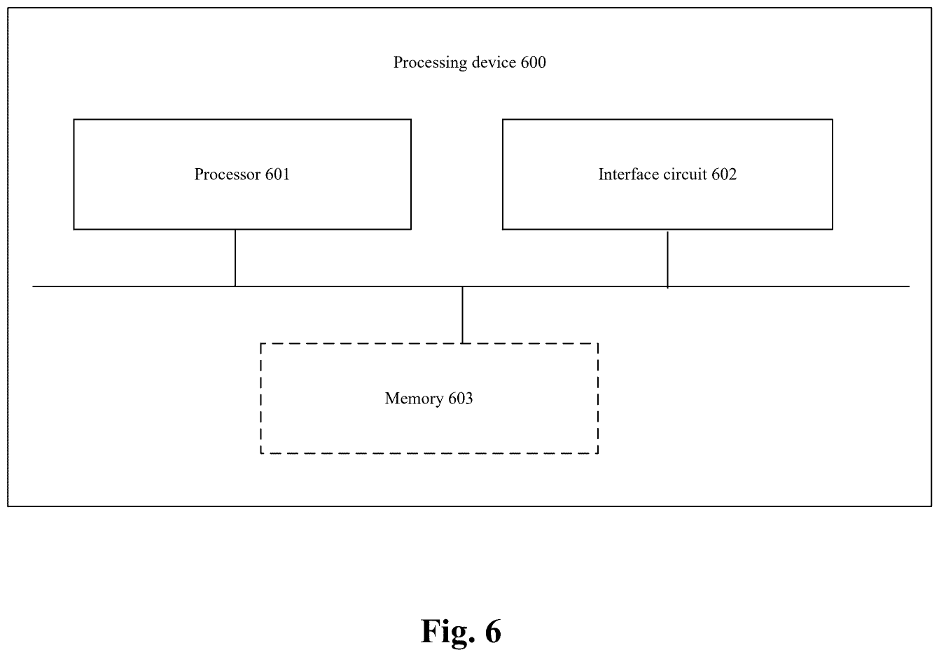

The above describes the method for coding the video signal provided by the present disclosure in conjunction with the accompanying drawings. The following describes the processing device provided by the present disclosure. FIGS. 5 and 6 are schematic diagrams of structures of possible processing devices provided by embodiments of the present disclosure. These processing devices may be configured to implement the functions of the processing device in the above method embodiments, and thus may also achieve the beneficial effects possessed by the above method embodiments. In the embodiment of the present disclosure, the processing device may be the processing device shown in FIG. 1, or may be an apparatus configured in the processing device.

FIG. 5 is a schematic diagram of a structure of a processing device 500 provided by this disclosure. The processing device may be implemented as a processing device itself or configured in a processing device through software, hardware or a combination of both. The processing device 500 includes a first ME unit 501 and a coding unit 502. The processing device 500 may further include a bus 503 for implementing communication connections between units and components. Optionally, the processing device 500 further includes a second ME unit 504 and a processing unit 505.

The first ME unit 501 is configured to determine a first rate-distortion cost and a second rate-distortion cost corresponding to a corresponding reference unit based on a set of deviations corresponding to each of a plurality of reference units contained in a reference frame at first pixel precision. The set of deviations is a set of scale deviations of co-located pixels between the corresponding reference unit and the unit to be coded. The scale may be luminance or chrominance. The first rate-distortion cost is a rate-distortion cost corresponding to first pixel precision. The second rate-distortion cost is a rate-distortion cost corresponding to second pixel precision.

The first ME unit 501 is also configured to output an optimal motion vector corresponding to the first pixel precision and a starting motion vector corresponding to the second pixel precision. The optimal motion vector corresponding to the first pixel precision is a motion vector between a reference unit with the smallest first rate-distortion cost among the plurality of reference units and the unit to be coded. The starting motion vector corresponding to the second pixel precision is a motion vector between the reference unit with the smallest second rate-distortion cost among the plurality of reference units and the unit to be coded. The starting motion vector corresponding to the second pixel precision is used to determine an optimal motion vector corresponding to the second pixel precision.

The coding unit 502 is configured to perform inter-frame coding on the unit to be coded according to a first optimal motion vector to output a coding sequence, where the first optimal motion vector is a motion vector with the smallest rate-distortion cost among optimal motion vectors corresponding to a plurality of pixel precisions, and the plurality of pixel precisions include the first pixel precision and the second pixel precision.

Optionally, the first ME unit 501 is further configured to determine a first code length based on a motion vector deviation between a first motion vector and a predicted motion vector. The first code length is a coding length of the motion vector deviation corresponding to the first pixel precision. The first motion vector is a motion vector between a first reference unit and the unit to be coded. The first rate-distortion cost corresponding to the first reference unit is determined based on the set of deviations corresponding to the first reference unit and the first code length, where the first reference unit is any one of the plurality of reference units. In addition, the first ME unit 501 is also configured to determine a second code length based on the motion vector deviation. The second code length is a coding length of the motion vector deviation corresponding to the second pixel precision. The second rate-distortion cost corresponding to the first reference unit is determined based on the set of deviations corresponding to the first reference unit and the second code length.

Optionally, the first ME unit 501 is further configured to obtain a starting motion vector corresponding to the first pixel precision. In addition, the first ME unit 501 is specifically configured to search for a matching reference unit of the unit to be coded corresponding to the first pixel precision in the reference frame at first pixel precision according to the starting motion vector corresponding to the first pixel precision, and determine the optimal motion vector corresponding to the first pixel precision and the starting motion vector corresponding to the second pixel precision.

Optionally, the second ME unit 504 is configured to obtain the starting motion vector corresponding to the second pixel precision. In addition, the second ME unit 504 is specifically configured to search for a matching reference unit of the unit to be coded corresponding to the second pixel precision in the reference frame at second pixel precision according to the starting motion vector corresponding to the second pixel precision, and determine the optimal motion vector corresponding to the second pixel precision.

Optionally, the second ME unit 504 is further configured to determine a starting motion vector corresponding to third pixel precision, and the plurality of pixel precisions include the third pixel precision.

Optionally, the processing unit 505 is configured to determine a second optimal motion vector, where the second optimal motion vector is a motion vector with the smallest rate-distortion cost among the optimal motion vectors corresponding to the plurality of pixel precisions. The processing unit 505 is also configured to, when the rate-distortion cost corresponding to the second optimal motion vector is greater than or equal to a threshold, use a second reference unit in the reference frame at target pixel precision as a starting point to search for a preset number of reference units using a target stride, and obtain rate-distortion costs corresponding to the preset number of reference units. The second reference unit is the reference unit corresponding to the second optimal motion vector. The target pixel precision is the pixel precision corresponding to the second reference unit. In addition, the processing unit 505 is also configured to determine that the updated optimal motion vector corresponding to the target pixel precision is the first optimal motion vector when the smallest rate-distortion cost among the rate-distortion costs corresponding to the preset number of reference units is less than the rate-distortion cost corresponding to the second reference unit. The first optimal motion vector is the motion vector between the reference unit corresponding to the smallest rate-distortion cost and the unit to be coded. Alternatively, the processing unit 505 is further configured to, when the smallest rate-distortion cost is greater than or equal to the rate-distortion cost corresponding to the second reference unit, determine the first optimal motion vector as the second optimal motion vector.

As shown in FIG. 6, a processing device 600 includes a processor 601 and an interface circuit 602. The processor 601 and the interface circuit 602 are coupled to each other. It is understood that the interface circuit 602 may be a transceiver or an input/output interface. Optionally, the processing device 600 may further include a memory 603 for storing instructions executed by the processor 601 or storing input data required by the processor 601 to run instructions or storing data generated after the processor 601 runs instructions. In a specific implementation, the memory 603 may also be integrated into the processor 601 or independent of the processor 601. In an implementation, the interface circuit 602 includes an input interface and an output interface.

When the processing device 600 is configured to implement the method shown in FIG. 3, the processor 601 is configured to implement the functions of the above-mentioned processing unit, and the interface circuit 602 is configured to implement the functions of the transceiver unit.

When the above-mentioned processing device is a chip applied to a processing device, the chip may realize the functions of the processing device in the above-mentioned method embodiment. The chip may obtain information/signals from other units in the processing device; or, the chip may output information/signals to other units in the processing device.

It should be understood that the processing device provided in the embodiments of the present disclosure may be a central processing unit (CPU), or may be other general-purpose processor, digital signal processor (DSP), application-specific integrated circuit (ASIC), etc. The general-purpose processor may be a microprocessor, or the processor may be any conventional processor or the like. The steps of the method disclosed in this disclosure may be directly implemented as being executed by a hardware processor, or may be implemented as being executed by a combination of hardware and software units in the processor.

The embodiment of the present disclosure further provides a readable storage medium, on which execution instructions are stored. When at least one processor of an electronic device executes the execution instructions, when computer execution instructions are executed by the processor, the image processing method in the above embodiment is implemented.

The embodiment of the present disclosure further provides a computer program product. The computer program product includes execution instructions. The execution instructions are stored in a readable storage medium. At least one processor of the electronic device may read the execution instructions from the readable storage medium, and the at least one processor executes the execution instructions so that the electronic device implements the image processing method provided by the various embodiments described above.

In several embodiments provided in this disclosure, it should be understood that the disclosed apparatus and method may be implemented in other ways. For instance, the apparatus embodiments described above are merely illustrative. For instance, a division of units is only a logical function division. In an actual implementation, there may be other division methods. For instance, a plurality of units or components may be combined or may be integrated in another system, or some features may be ignored or may not be performed. In addition, the displayed or discussed mutual coupling or direct coupling or communication connection may be implemented through indirect coupling or communication connection of some interfaces, devices or units, and may be electrical or other forms.

Units described as separate components may or may not be physically separated. Components shown as units may or may not be physical units. In other words, the components may be located in one place or distributed to a plurality of network units. According to actual needs, some or all of the units can be selected for realizing the purposes of the examples of the present disclosure.

In addition, the functional units in each example of the present disclosure may be integrated into one processing module, or each of the units may exist separately and physically, or two or more units may be integrated into one module. The above integrated unit may be implemented in the form of hardware or in the form of hardware plus software function units.

The above integrated unit implemented in the form of software function unit may be stored in a computer-readable storage medium. The above software function unit is stored in a storage medium, including several instructions for enabling a computer device (which may be a personal computer, server, or network device, etc.) or a processor to perform some steps of the method in each embodiment of the present disclosure. The above storage media include: USB flash drives, mobile hard drives, read-only memories (ROM), random access memories (RAM), magnetic disks or optical disks, and other media that may store program codes.

Those skilled in the art, after considering the specification and practicing the invention disclosed herein, will readily think of other embodiments of the present disclosure. This application is intended to cover any variation, use or adaptation of this application that follows general principles of this application and includes common knowledge or customary techniques in the field of technology not disclosed in this application. The specification and embodiments are to be regarded as exemplary only, and the true scope and spirit of this disclosure are indicated by the claims below.

The foregoing may be better understood in light of the following articles:

Article 1. A method for coding a video signal, including:
determining a first rate-distortion cost and a second rate-distortion cost corresponding to a corresponding reference unit based on a set of deviations corresponding to each of a plurality of reference units contained in a reference frame at first pixel precision, where the set of deviations is a set of scale deviations of co-located pixels between the corresponding reference unit and a unit to be coded, the first rate-distortion cost is a rate-distortion cost corresponding to first pixel precision, and the second rate-distortion cost is a rate-distortion cost corresponding to second pixel precision;
determining an optimal motion vector corresponding to the first pixel precision and a starting motion vector corresponding to the second pixel precision, where the optimal motion vector corresponding to the first pixel precision is a motion vector between a reference unit with a smallest first rate-distortion cost among the plurality of reference units and the unit to be coded, the starting motion vector corresponding to the second pixel precision is a motion vector between a reference unit with a smallest second rate-distortion cost among the plurality of reference units and the unit to be coded, and the starting motion vector corresponding to the second pixel precision is used to determine an optimal motion vector corresponding to the second pixel precision; and
performing inter-frame coding on the unit to be coded according to a first optimal motion vector to output a coding sequence, where the first optimal motion vector is a motion vector with a smallest rate-distortion cost among optimal motion vectors corresponding to a plurality of pixel precisions, and the plurality of pixel precisions include the first pixel precision and the second pixel precision.

Article 2. The method of article 1, where determining the first rate-distortion cost and the second rate-distortion cost includes:
determining a first code length based on a motion vector deviation between a first motion vector and a predicted motion vector, where the first code length is a coding length of the motion vector deviation corresponding to the first pixel precision, the first motion vector is a motion vector between a first reference unit and the unit to be coded, and a first rate-distortion cost corresponding to the first reference unit is determined based on a set of deviations corresponding to the first reference unit and the first code length; and
determining a second code length based on the motion vector deviation, where the second code length is a coding length of the motion vector deviation corresponding to the second pixel precision, and a second rate-distortion cost corresponding to the first reference unit is determined based on the set of deviations corresponding to the first reference unit and the second code length.

Article 3. The method of article 1 or 2, further including:
obtaining a starting motion vector corresponding to the first pixel precision; and
determining the optimal motion vector corresponding to the first pixel precision and the starting motion vector corresponding to the second pixel precision includes:
searching for a matching reference unit of the unit to be coded corresponding to the first pixel precision in the reference frame at the first pixel precision based on the starting motion vector corresponding to the first pixel precision to determine the optimal motion vector corresponding to the first pixel precision and the starting motion vector corresponding to the second pixel precision.

Article 4. The method of article 1 or 2, further including:
searching for a matching reference unit of the unit to be coded corresponding to the second pixel precision in the reference frame at the second pixel precision based on the starting motion vector corresponding to the second pixel precision to determine the optimal motion vector corresponding to the second pixel precision.

Article 5. The method of article 4, further including:
determining a starting motion vector corresponding to third pixel precision, where the plurality of pixel precisions include the third pixel precision.

Article 6. The method of article 1 or 2, where before performing the inter-frame coding on the unit to be coded according to the first optimal motion vector to output the coding sequence, the method further includes:
determining a second optimal motion vector, where the second optimal motion vector is the motion vector with the smallest rate-distortion cost among the optimal motion vectors corresponding to the plurality of pixel precisions;
when the rate-distortion cost corresponding to the second optimal motion vector is greater than or equal to a threshold, using a second reference unit in a reference frame at target pixel precision as a search starting reference unit, and searching for a preset number of reference units using a target stride to obtain rate-distortion costs corresponding to the preset number of reference units, where the second reference unit is a reference unit corresponding to the second optimal motion vector, and the target pixel precision is a pixel precision corresponding to the second reference unit; and
when a smallest rate-distortion cost among the rate-distortion costs corresponding to the preset number of reference units is less than the rate-distortion cost corresponding to the second reference unit, determining that the updated optimal motion vector corresponding to the target pixel precision is the first optimal motion vector, where the first optimal motion vector is a motion vector between a reference unit corresponding to the smallest rate-distortion cost and the unit to be coded; or
when the smallest rate-distortion cost is greater than or equal to the rate-distortion cost corresponding to the second reference unit, determining not to update the optimal motion vector corresponding to the target pixel precision, where the first optimal motion vector is the second optimal motion vector.

Article 7. A processing device, including:
a first motion estimation (ME) unit configured to:
determine a first rate-distortion cost and a second rate-distortion cost corresponding to a corresponding reference unit based on a set of deviations corresponding to each of a plurality of reference units contained in a reference frame at first pixel precision, where the set of deviations is a set of scale deviations of co-located pixels between the corresponding reference unit and a unit to be coded, the first rate-distortion cost is a rate-distortion cost corresponding to first pixel precision, and the second rate-distortion cost is a rate-distortion cost corresponding to second pixel precision; and
output an optimal motion vector corresponding to the first pixel precision and a starting motion vector corresponding to the second pixel precision, where the optimal motion vector corresponding to the first pixel precision is a motion vector between a reference unit with a smallest first rate-distortion cost among the plurality of reference units and the unit to be coded, the starting motion vector corresponding to the second pixel precision is a motion vector between a reference unit with a smallest second rate-distortion cost among the plurality of reference units and the unit to be coded, and the starting motion vector corresponding to the second pixel precision is used to determine an optimal motion vector corresponding to the second pixel precision; and
a coding unit configured to perform inter-frame coding on the unit to be coded according to a first optimal motion vector to output a coding sequence, where the first optimal motion vector is a motion vector with a smallest rate-distortion cost among optimal motion vectors corresponding to a plurality of pixel precisions, and the plurality of pixel precisions include the first pixel precision and the second pixel precision.

Article 8. The device of article 7, where
the first ME unit is further configured to:
determine a first code length based on a motion vector deviation between a first motion vector and a predicted motion vector, where the first code length is a coding length of the motion vector deviation corresponding to the first pixel precision, the first motion vector is a motion vector between a first reference unit and the unit to be coded, and a first rate-distortion cost corresponding to the first reference unit is determined based on a set of deviations corresponding to the first reference unit and the first code length; and
determine a second code length based on the motion vector deviation, where the second code length is a coding length of the motion vector deviation corresponding to the second pixel precision, and a second rate-distortion cost corresponding to the first reference unit is determined based on the set of deviations corresponding to the first reference unit and the second code length.

Article 9. The device of article 7 or 8, where
the first ME unit is further configured to:
obtain a starting motion vector corresponding to the first pixel precision; and
specifically, search for a matching reference unit of the unit to be coded corresponding to the first pixel precision in the reference frame at the first pixel precision based on the starting motion vector corresponding to the first pixel precision to determine the optimal motion vector corresponding to the first pixel precision and the starting motion vector corresponding to the second pixel precision.

Article 10. The device of article 7 or 8, including:
a second ME unit configured to:
obtain the starting motion vector corresponding to the second pixel precision; and
search for a matching reference unit of the unit to be coded corresponding to the second pixel precision in the reference frame at the second pixel precision based on the starting motion vector corresponding to the second pixel precision to determine the optimal motion vector corresponding to the second pixel precision.

Article 11. The device of article 10, where
the second ME unit is further configured to determine a starting motion vector corresponding to third pixel precision, where the plurality of pixel precisions include the third pixel precision.

Article 12. The device of article 7 or 8, including:
a processing unit configured to:
determine a second optimal motion vector, where the second optimal motion vector is the motion vector with the smallest rate-distortion cost among the optimal motion vectors corresponding to the plurality of pixel precisions;
when the rate-distortion cost corresponding to the second optimal motion vector is greater than or equal to a threshold, use a second reference unit in a reference frame at target pixel precision as a search starting reference unit, and search for a preset number of reference units using a target stride to obtain rate-distortion costs corresponding to the preset number of reference units, where the second reference unit is a reference unit corresponding to the second optimal motion vector, and the target pixel precision is a pixel precision corresponding to the second reference unit; and
when a smallest rate-distortion cost among the rate-distortion costs corresponding to the preset number of reference units is less than the rate-distortion cost corresponding to the second reference unit, determine that the updated optimal motion vector corresponding to the target pixel precision is the first optimal motion vector, where the first optimal motion vector is a motion vector between a reference unit corresponding to the smallest rate-distortion cost and the unit to be coded; or
when the smallest rate-distortion cost is greater than or equal to the rate-distortion cost corresponding to the second reference unit, determine not to update the optimal motion vector corresponding to the target pixel precision, where the first optimal motion vector is the second optimal motion vector.

Article 13. A processing device, including: a processor and a memory, where
the memory is configured to store computer execution instructions; and
the processor is configured to execute the computer execution instructions stored in the memory, so that the processing device performs the method of any one of articles 1-6.

Article 14. A chip, including a logic circuit and an input/output interface, where
the logic circuit is configured to control the input/output interface and perform the method of any one of articles 1-6.

Article 15. A computer-readable storage medium, on which computer execution instructions are stored, where the computer execution instructions are used to implement the method of any one of articles 1-6 when performed by a processor.

It should be understood that this disclosure is not limited to the precise structure already described above and shown in the attached drawings, and that various modifications and changes may be made without deviating from the scope of this disclosure. The scope of this application is limited only by the attached claims.

1. A method for coding a video signal, comprising:
determining a first rate-distortion cost and a second rate-distortion cost corresponding to a corresponding reference unit based on a set of deviations corresponding to each of a plurality of reference units contained in a reference frame at first pixel precision, wherein the set of deviations is a set of scale deviations of co-located pixels between the corresponding reference unit and a unit to be coded, the first rate-distortion cost is a rate-distortion cost corresponding to first pixel precision, and the second rate-distortion cost is a rate-distortion cost corresponding to second pixel precision;
determining an optimal motion vector corresponding to the first pixel precision and a starting motion vector corresponding to the second pixel precision, wherein the optimal motion vector corresponding to the first pixel precision is a motion vector between a reference unit with a smallest first rate-distortion cost among the plurality of reference units and the unit to be coded, the starting motion vector corresponding to the second pixel precision is a motion vector between a reference unit with a smallest second rate-distortion cost among the plurality of reference units and the unit to be coded, and the starting motion vector corresponding to the second pixel precision is used to determine an optimal motion vector corresponding to the second pixel precision; and
performing inter-frame coding on the unit to be coded according to a first optimal motion vector to output a coding sequence, wherein the first optimal motion vector is a motion vector with a smallest rate-distortion cost among optimal motion vectors corresponding to a plurality of pixel precisions, and the plurality of pixel precisions comprise the first pixel precision and the second pixel precision.

2. The method of claim 1, wherein determining the first rate-distortion cost and the second rate-distortion cost comprises:
determining a first code length based on a motion vector deviation between a first motion vector and a predicted motion vector, wherein the first code length is a coding length of the motion vector deviation corresponding to the first pixel precision, the first motion vector is a motion vector between a first reference unit and the unit to be coded, and a first rate-distortion cost corresponding to the first reference unit is determined based on a set of deviations corresponding to the first reference unit and the first code length; and
determining a second code length based on the motion vector deviation, wherein the second code length is a coding length of the motion vector deviation corresponding to the second pixel precision, and a second rate-distortion cost corresponding to the first reference unit is determined based on the set of deviations corresponding to the first reference unit and the second code length.

3. The method of claim further comprising:
obtaining a starting motion vector corresponding to the first pixel precision; and
determining the optimal motion vector corresponding to the first pixel precision and the starting motion vector corresponding to the second pixel precision comprises:
searching for a matching reference unit of the unit to be coded corresponding to the first pixel precision in the reference frame at the first pixel precision based on the starting motion vector corresponding to the first pixel precision to determine the optimal motion vector corresponding to the first pixel precision and the starting motion vector corresponding to the second pixel precision.

4. The method of claim 1, further comprising:
searching for a matching reference unit of the unit to be coded corresponding to the second pixel precision in the reference frame at the second pixel precision based on the starting motion vector corresponding to the second pixel precision to determine the optimal motion vector corresponding to the second pixel precision.

5. The method of claim 4, further comprising:
determining a starting motion vector corresponding to third pixel precision, wherein the plurality of pixel precisions comprise the third pixel precision.

6. The method of claim 1, wherein before performing the inter-frame coding on the unit to be coded according to the first optimal motion vector to output the coding sequence, the method further comprises:
determining a second optimal motion vector, wherein the second optimal motion vector is the motion vector with the smallest rate-distortion cost among the optimal motion vectors corresponding to the plurality of pixel precisions;
when the rate-distortion cost corresponding to the second optimal motion vector is greater than or equal to a threshold, using a second reference unit in a reference frame at target pixel precision as a search starting reference unit, and searching for a preset number of reference units using a target stride to obtain rate-distortion costs corresponding to the preset number of reference units, wherein the second reference unit is a reference unit corresponding to the second optimal motion vector, and the target pixel precision is a pixel precision corresponding to the second reference unit; and
when a smallest rate-distortion cost among the rate-distortion costs corresponding to the preset number of reference units is less than the rate-distortion cost corresponding to the second reference unit, determining that the updated optimal motion vector corresponding to the target pixel precision is the first optimal motion vector, wherein the first optimal motion vector is a motion vector between a reference unit corresponding to the smallest rate-distortion cost and the unit to be coded; or
when the smallest rate-distortion cost is greater than or equal to the rate-distortion cost corresponding to the second reference unit, determining not to update the optimal motion vector corresponding to the target pixel precision, wherein the first optimal motion vector is the second optimal motion vector.

7. A processing device, comprising:
a first motion estimation (ME) unit configured to:
determine a first rate-distortion cost and a second rate-distortion cost corresponding to a corresponding reference unit based on a set of deviations corresponding to each of a plurality of reference units contained in a reference frame at first pixel precision, wherein the set of deviations is a set of scale deviations of co-located pixels between the corresponding reference unit and a unit to be coded, the first rate-distortion cost is a rate-distortion cost corresponding to first pixel precision, and the second rate-distortion cost is a rate-distortion cost corresponding to second pixel precision; and
output an optimal motion vector corresponding to the first pixel precision and a starting motion vector corresponding to the second pixel precision, wherein the optimal motion vector corresponding to the first pixel precision is a motion vector between a reference unit with a smallest first rate-distortion cost among the plurality of reference units and the unit to be coded, the starting motion vector corresponding to the second pixel precision is a motion vector between a reference unit with a smallest second rate-distortion cost among the plurality of reference units and the unit to be coded, and the starting motion vector corresponding to the second pixel precision is used to determine an optimal motion vector corresponding to the second pixel precision; and
a coding unit configured to perform inter-frame coding on the unit to be coded according to a first optimal motion vector to output a coding sequence, wherein the first optimal motion vector is a motion vector with a smallest rate-distortion cost among optimal motion vectors corresponding to a plurality of pixel precisions, and the plurality of pixel precisions comprise the first pixel precision and the second pixel precision.

8. The device of claim 7, wherein
the first ME unit is further configured to:
determine a first code length based on a motion vector deviation between a first motion vector and a predicted motion vector, wherein the first code length is a coding length of the motion vector deviation corresponding to the first pixel precision, the first motion vector is a motion vector between a first reference unit and the unit to be coded, and a first rate-distortion cost corresponding to the first reference unit is determined based on a set of deviations corresponding to the first reference unit and the first code length; and
determine a second code length based on the motion vector deviation, wherein the second code length is a coding length of the motion vector deviation corresponding to the second pixel precision, and a second rate-distortion cost corresponding to the first reference unit is determined based on the set of deviations corresponding to the first reference unit and the second code length.

9. The device of claim 7, wherein
the first ME unit is further configured to:
obtain a starting motion vector corresponding to the first pixel precision; and
specifically, search for a matching reference unit of the unit to be coded corresponding to the first pixel precision in the reference frame at the first pixel precision based on the starting motion vector corresponding to the first pixel precision to determine the optimal motion vector corresponding to the first pixel precision and the starting motion vector corresponding to the second pixel precision.

10. The device of claim 7, comprising:
a second ME unit configured to:
obtain the starting motion vector corresponding to the second pixel precision; and
search for a matching reference unit of the unit to be coded corresponding to the second pixel precision in the reference frame at the second pixel precision based on the starting motion vector corresponding to the second pixel precision to determine the optimal motion vector corresponding to the second pixel precision.

11. The device of claim 10, wherein the second ME unit is further configured to determine a starting motion vector corresponding to third pixel precision, wherein the plurality of pixel precisions comprise the third pixel precision.

12. The device of claim 7, comprising:
a processing unit configured to:
determine a second optimal motion vector, wherein the second optimal motion vector is the motion vector with the smallest rate-distortion cost among the optimal motion vectors corresponding to the plurality of pixel precisions;
when the rate-distortion cost corresponding to the second optimal motion vector is greater than or equal to a threshold, use a second reference unit in a reference frame at target pixel precision as a search starting reference unit, and search for a preset number of reference units using a target stride to obtain rate-distortion costs corresponding to the preset number of reference units, wherein the second reference unit is a reference unit corresponding to the second optimal motion vector, and the target pixel precision is a pixel precision corresponding to the second reference unit; and
when a smallest rate-distortion cost among the rate-distortion costs corresponding to the preset number of reference units is less than the rate-distortion cost corresponding to the second reference unit, determine that the updated optimal motion vector corresponding to the target pixel precision is the first optimal motion vector, wherein the first optimal motion vector is a motion vector between a reference unit corresponding to the smallest rate-distortion cost and the unit to be coded; or
when the smallest rate-distortion cost is greater than or equal to the rate-distortion cost corresponding to the second reference unit, determine not to update the optimal motion vector corresponding to the target pixel precision, wherein the first optimal motion vector is the second optimal motion vector.

13. A processing device, comprising: a processor and a memory, wherein
the memory is configured to store computer execution instructions; and
the processor is configured to execute the computer execution instructions stored in the memory, so that the processing device performs the method of claim 1.

14. A chip, comprising a logic circuit and an input/output interface, wherein
the logic circuit is configured to control the input/output interface and perform the method of claim 1.

15. A computer-readable storage medium, on which computer execution instructions are stored, wherein the computer execution instructions are used to implement the method of claim 1 when performed by a processor.

16. The method of claim 2, further comprising:
obtaining a starting motion vector corresponding to the first pixel precision; and
determining the optimal motion vector corresponding to the first pixel precision and the starting motion vector corresponding to the second pixel precision comprises:
searching for a matching reference unit of the unit to be coded corresponding to the first pixel precision in the reference frame at the first pixel precision based on the starting motion vector corresponding to the first pixel precision to determine the optimal motion vector corresponding to the first pixel precision and the starting motion vector corresponding to the second pixel precision.

17. The method of claim 2, further comprising:
searching for a matching reference unit of the unit to be coded corresponding to the second pixel precision in the reference frame at the second pixel precision based on the starting motion vector corresponding to the second pixel precision to determine the optimal motion vector corresponding to the second pixel precision.

18. The method of claim 17, further comprising:
determining a starting motion vector corresponding to third pixel precision, wherein the plurality of pixel precisions comprise the third pixel precision.

19. The method of claim 2, wherein before performing the inter-frame coding on the unit to be coded according to the first optimal motion vector to output the coding sequence, the method further comprises:
determining a second optimal motion vector, wherein the second optimal motion vector is the motion vector with the smallest rate-distortion cost among the optimal motion vectors corresponding to the plurality of pixel precisions;
when the rate-distortion cost corresponding to the second optimal motion vector is greater than or equal to a threshold, using a second reference unit in a reference frame at target pixel precision as a search starting reference unit, and searching for a preset number of reference units using a target stride to obtain rate-distortion costs corresponding to the preset number of reference units, wherein the second reference unit is a reference unit corresponding to the second optimal motion vector, and the target pixel precision is a pixel precision corresponding to the second reference unit; and
when a smallest rate-distortion cost among the rate-distortion costs corresponding to the preset number of reference units is less than the rate-distortion cost corresponding to the second reference unit, determining that the updated optimal motion vector corresponding to the target pixel precision is the first optimal motion vector, wherein the first optimal motion vector is a motion vector between a reference unit corresponding to the smallest rate-distortion cost and the unit to be coded; or
when the smallest rate-distortion cost is greater than or equal to the rate-distortion cost corresponding to the second reference unit, determining not to update the optimal motion vector corresponding to the target pixel precision, wherein the first optimal motion vector is the second optimal motion vector.

20. The device of claim 8, wherein
the first ME unit is further configured to:
obtain a starting motion vector corresponding to the first pixel precision; and
specifically, search for a matching reference unit of the unit to be coded corresponding to the first pixel precision in the reference frame at the first pixel precision based on the starting motion vector corresponding to the first pixel precision to determine the optimal motion vector corresponding to the first pixel precision and the starting motion vector corresponding to the second pixel precision.
